(19) United States
(12) Patent Application Publication
(10) Pub. No.: US 2026/0044537 A1
(43) Pub. Date: Feb. 12, 2026

(54) INFORMATION PROCESSING SYSTEM, INFORMATION PROCESSING PROGRAM, AND INFORMATION PROCESSING METHOD

(71) Applicant: AIDAO Co., Ltd., Tokyo (JP)

(72) Inventor: Mitsushi MURATA, Tokyo (JP)

(73) Assignee: AIDAO Co., Ltd., Tokyo (JP)

(21) Appl. No.: 19/363,720

(22) Filed: Oct. 21, 2025

Related U.S. Application Data
(63) Continuation of application No. PCT/JP2024/016371, filed on Apr. 26, 2024.

(30) Foreign Application Priority Data
Apr. 26, 2023 (JP) 2023-072811

(51) Int. Cl. G06F 16/332; G06F 16/3329

(52) U.S. Cl. CPC G06F 16/3325; G06F 16/33295

(57) ABSTRACT

An information processing system enabling efficient collection of data comprises: a learning model storage storing a trained machine learning model; an input receiving unit configured to receive input data from a first user; a processing circuitry configured to provide the input data to the trained model to generate output data; an output unit configured to output the output data in a manner viewable by the first user and a second user different from the first user, or by the second user only; and a correction result receiving unit configured to receive a correction result in which the second user has revised the output data.

### CROSS-REFERENCE RELATED TO APPLICATIONS

The present application is a bypass continuation of, and claims priority to, International application PCT/JP2024/016371, filed Apr. 26, 2024, the entire contents of which is incorporated herein by reference. PCT/JP2024/016371 claims priority to JP 2023-072811, filed Apr. 26, 2023, the entire contents of which is incorporated herein by reference.

### TECHNICAL FIELD

The present disclosure relates generally to an information processing system, an information processing program, and an information processing method.

### BACKGROUND ART

Conventionally, technologies have been developed to enable machines to automatically respond to questions and requests from users, and such technologies have been provided as automated response services such as bots. For example, Japanese patent publication 2009-003533 discloses a related technology.

### SUMMARY

In conventional technologies where a machine automatically provides a response, it is necessary to predefine rules for responses or to prepare a large volume of training data for constructing a machine learning model. Such approaches require enormous costs for human labor, computer resources, training time for machines, and the like.

The present disclosure has been made in view of the problem, as well as other problems, of the conventional art, and the present disclosure addresses these issues, as discussed here, with a technology capable of efficiently collecting data.

According to one embodiment of the present disclosure, there is provided an information processing system comprising: a learning model storage storing a trained model obtained through machine learning; an input data receiving unit configured to receive input data from a first user; a processing circuitry configured to provide the input data to the trained model to generate output data; an output unit configured to output the output data in a manner viewable by both the first user and a second user different from the first user, or only by the second user; and a correction result receiving unit configured to receive a correction result in which the second user has corrected the output data.

### BRIEF DESCRIPTION OF THE DRAWINGS

FIG. 1 is a diagram illustrating an overview of an information processing system according to the present disclosure.

FIG. 2 is a diagram illustrating an example of a question management table.

FIG. 3 is a diagram illustrating an example of a response management table.

FIG. 4 is a diagram illustrating an example of a correction result management table.

FIG. 5 is a diagram illustrating an example of a question evaluation management table.

FIG. 6 is a diagram illustrating an example of a correction content evaluation management table.

FIG. 7 is a diagram illustrating an example of a questioner management table.

FIG. 8 is a diagram illustrating an example of a corrector management table.

FIG. 9 is a diagram illustrating an example flow of processing performed by a learning unit.

FIG. 10 is a diagram illustrating an example flow of processing performed by a question quality determination unit.

FIG. 11 is a diagram illustrating an example flow of processing performed by a correction quality determination unit.

FIG. 12 is a diagram illustrating an example flow of incentive calculation processing for a user who submitted a question.

FIG. 13 is a diagram illustrating an example flow of incentive calculation processing for a user who corrected a response.

FIG. 14 is a diagram illustrating an example hardware configuration of a computer.

### DESCRIPTION OF EMBODIMENTS

Embodiments of an information processing system, an information processing program, and an information processing method according to the present disclosure will be described below. For example, the information processing system, information processing program, and information processing method according to the present disclosure may comprise the following configurations.

### (Configuration 1)

An information processing system according to the present disclosure comprises: a learning model storage storing a trained model obtained through machine learning; an input data receiving unit configured to receive input data from a first user; a processing circuitry configured to provide the input data to the trained model to generate output data; an output unit configured to output the output data in a manner viewable by both the first user and a second user different from the first user, or only by the second user; a correction result receiving unit configured to receive a correction result in which the second user has corrected the output data; and an update unit configured to update the trained model using the correction result.

### (Configuration 2)

The information processing system according to Configuration 1 may further comprise an expert storage storing information on whether a user is an expert. The output unit may identify the expert as the second user by referring to the expert storage, output the output data only to the identified second user, and output the correction result corrected by the second user, to the first user in a viewable manner.

### (Configuration 3)

The information processing system according to Configuration 1 may further comprise a correction evaluation receiving unit configured to receive an evaluation value for the correction result, from a third user. The output unit may output the input data and the correction result to the third user in a viewable manner. The correction result receiving unit may receive the correction result from a plurality of the second users, and the update unit may select a correction result based on the evaluation value and update the trained model using the selected correction result.

### (Configuration 4)

The information processing system according to Configuration 3 may further comprise a correction quality determination unit configured to aggregate the evaluation values for each of the correction results to determine quality of each correction result. The update unit may select at least a part of the correction results based on the quality.

### (Configuration 5)

In the information processing system according to Configuration 4, the correction quality determination unit may determine the quality based on the aggregated value of the evaluation values and/or the number of the third users who have viewed the correction result.

### (Configuration 6)

The information processing system according to Configuration 1 may further comprise an input evaluation receiving unit configured to receive an evaluation value for the input data, from the third user. The output unit may output the input data in a viewable manner to the second user and the third user. The update unit may update the trained model using the input data having the evaluation value equal to or greater than a predetermined value and the correction result of the output data corresponding to that input data.

### (Configuration 7)

In the information processing system according to Configuration 6, the input evaluation receiving unit may receive the evaluation value from a plurality of the third users, and may further comprise an input quality determination unit configured to aggregate the evaluation values to determine quality of each input data. The update unit may update the trained model using the input data having the quality whose aggregated value is equal to or greater than a predetermined value and the correction result corresponding to that input data.

### (Configuration 8)

In the information processing system according to Configuration 7, the input quality determination unit may determine the quality based on the aggregated value of the evaluation values and/or the number of the third users who have viewed the input data.

### (Configuration 9)

The information processing system according to Configuration 1 may further comprise: the correction evaluation receiving unit configured to receive an evaluation value for the correction result, from the third user; the correction quality determination unit configured to determine correction quality, which is quality of the correction result, based on an aggregated value of the evaluation values and/or the number of the third users who have viewed the correction result; the input evaluation receiving unit configured to receive the evaluation value of the input data from the third user; and the input quality determination unit configured to determine input quality, which is quality of the input data, based on an aggregated value of the evaluation values and/or the number of the third users who have viewed the input data. The output unit may output the input data and the correction result in a viewable manner to the second user and the third user. The update unit may update the trained model using the input data having the input quality whose aggregated value is equal to or greater than a first predetermined value and the correction result having the correction quality whose aggregated value is equal to or greater than a second predetermined value.

### (Configuration 10)

The information processing system according to Configuration 1 may further comprise an incentive granting unit configured to provide an incentive to the second user who has provided the correction result.

### (Configuration 11)

The information processing system according to Configuration 1 may further comprise an incentive granting unit configured to provide an incentive to the first user who has provided the input data.

### (Configuration 12)

The information processing system according to Configuration 3 may further comprise an incentive granting unit configured to provide an incentive to the third user.

### (Configuration 13)

In the information processing system according to Configuration 1, the update unit may determine whether the correction result is public information, and may update the trained model using the correction result that is not public information.

### (Configuration 14)

An information processing program according to the present disclosure causes a computer to execute: storing a trained model obtained through machine learning; receiving input data from a first user; providing the input data to the trained model to generate output data; outputting the output data in a manner viewable by both the first user and a second user different from the first user, or only by the second user; receiving a correction result in which the second user has corrected the output data; and updating the trained model using the correction result.

### (Configuration 15)

An information processing method according to the present disclosure, which is executed by a computer, comprising: storing a trained model obtained through machine learning; receiving input data from a first user; providing the input data to the trained model to generate output data; outputting the output data in a manner viewable by both the first user and a second user different from the first user, or only by the second user; receiving a correction result in which the second user has corrected the output data; and updating the trained model using the correction result.

### <System Configuration>

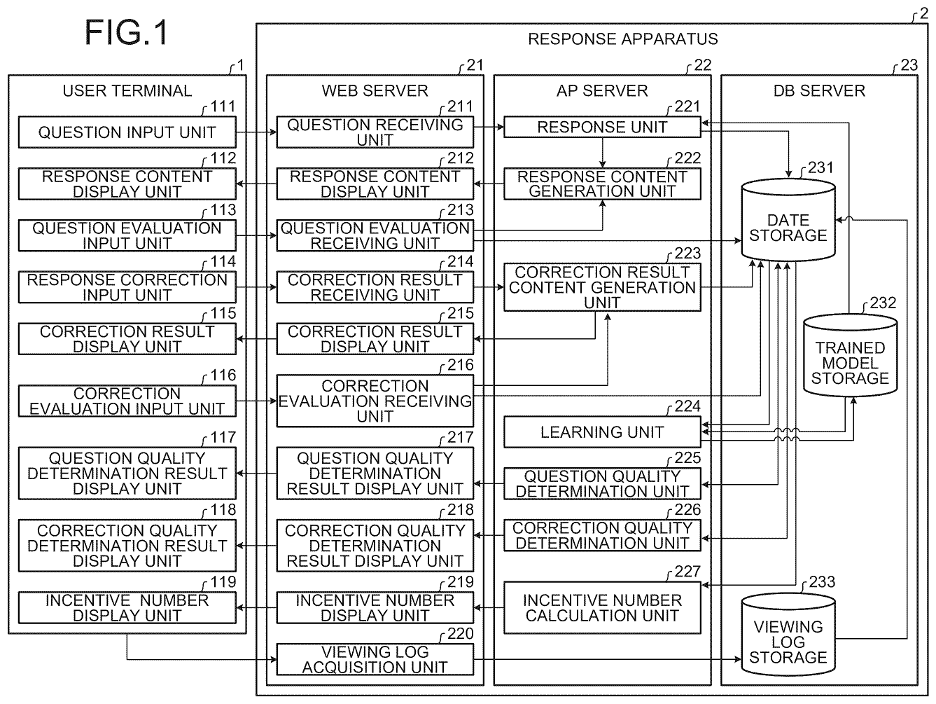

FIG. 1 is a diagram illustrating an overview of an information processing system according to the present disclosure. An information processing system of the present embodiment includes a response apparatus 2. The response apparatus 2 is communicably connected with a user terminal 1 via a communication network. For example, the communication network may be the Internet. The communication network may include, for example, a public switched telephone network, a cellular network, a wireless communication path, or Ethernet.

The user terminal 1 may be a computer operated by a user. For example, a smartphone, a tablet computer, or a personal computer may be used as the user terminal 1. A web browser or an application is executed on the user terminal 1. A user can access the response apparatus 2 via the web browser or the application.

The response apparatus 2 may be implemented by a general-purpose computer such as a workstation or a personal computer. Alternatively, the response apparatus 2 may be logically implemented through cloud computing.

In the information processing system, the response apparatus 2 stores therein a machine learning model trained by machine learning, which is used for generating an answer to a question. The information processing system generates an answer to a question from a user (a questioner) by using the machine learning model, receives a correction of the generated answer from another user (a corrector) different from the questioner, and updates the machine learning model using the correction result. In this manner, the machine learning model is autonomously updated so as to obtain more up-to-date information and to improve accuracy by utilizing resources distributed among users. The information processing system also receives evaluations of questions and correction results from users (viewers/evaluators) who have viewed the questions and the correction results. The information processing system may retrain the machine learning model using highly evaluated questions and/or highly evaluated correction results. The retrained machine learning model may thereby be updated to generate more accurate answers.

In the example of the present embodiment, the corrector is a user different from the questioner, the evaluator who evaluates a question is a user different from the questioner, and the evaluator who evaluates a correction result is a user different from the corrector. It is also possible that the correctors may include the questioner, and/or the evaluators may include the questioner or the corrector. There may be one or more questioners. There may be one or more correctors. There may be one or more evaluators.

### <Software Configuration>

As shown in FIG. 1, the user terminal 1 comprises: a question input unit 111; a response content display unit 112; a question evaluation input unit 113; a response correction input unit 114; a correction result display unit 115; a correction evaluation input unit 116; a question quality determination result display unit 117; a correction quality determination result display unit 118; and an incentive number display unit 119.

As shown in FIG. 1, the response apparatus 2 comprises: a web server 21 that performs data transmission and reception with the user terminal 1; an application server (AP server) 22 functioning as middleware; and a database (DB) server 23 that manages databases. This configuration is merely an example, and the response apparatus 2 may be configured with one or two computers. Alternatively, the response apparatus 2 may be configured with four or more computers.

The DB server 23 includes a data storage 231, a trained model storage 232, and a viewing log storage 233.

The web server 21 includes: a question receiving unit 211; a response content display unit 212; a question evaluation receiving unit 213; a correction result receiving unit 214; a correction result display unit 215; a correction evaluation receiving unit 216; a question quality determination result display unit 217; a correction quality determination result display unit 218; an incentive number display unit 219; and a viewing log acquisition unit 220.

The application server (AP server) 22 includes: a response unit 221; a response content generation unit 222; a correction result content generation unit 223; a learning unit 224; a question quality determination unit 225; a correction quality determination unit 226; and an incentive number calculation unit 227.

The data storage 231 of the DB server 23 includes: a question management table 311; a response management table 312; a correction result management table 313; a question evaluation management table 314; a correction content evaluation management table 315; a questioner management table 316; and a corrector management table 317.

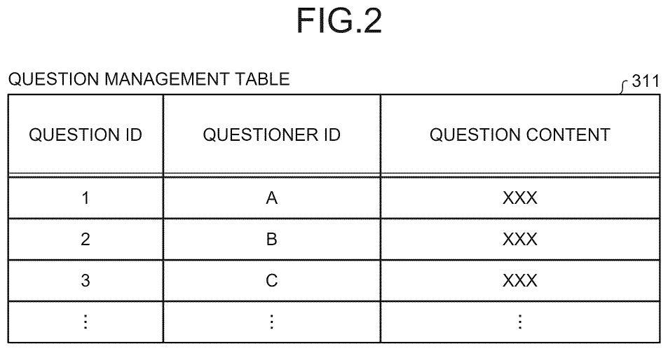

The question management table 311 is a table for managing information (hereinafter referred to as “question information”) related to questions received from users (questioners). FIG. 2 is a diagram illustrating an example of the question management table 311. Question records (question information) managed in the question management table 311 include information (question ID) for identifying a question, information (questioner ID) for identifying the user who asked the question, and the question content.

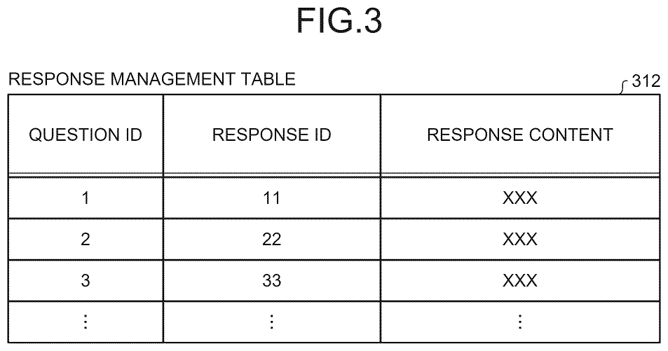

The response management table 312 is a table for managing information (hereinafter referred to as “response information”) related to content of automatic responses to questions from users (questioners). FIG. 3 is a diagram illustrating an example of the response management table 312. Response records (response information) registered in the response management table 312 include a question ID for identifying a question, information (response ID) for identifying a response, and the response content.

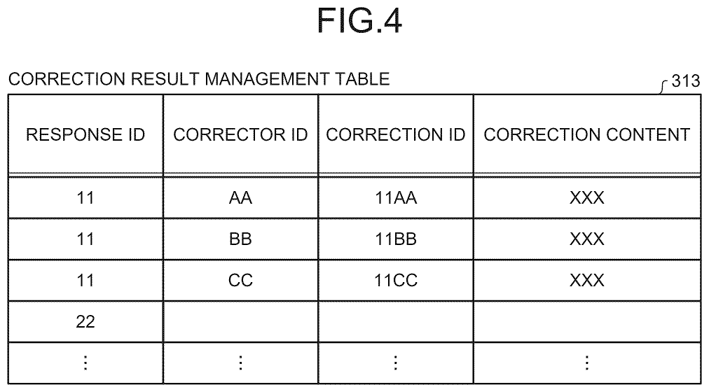

The correction result management table 313 is a table for managing information (hereinafter referred to as “correction result information”) related to corrections, received from users (correctors), for automatically generated responses. FIG. 4 is a diagram illustrating an example of the correction result management table 313. Correction result records (correction result information) managed in the correction result management table 313 include a response ID for identifying a response, information (corrector ID) for identifying the user who performed the correction, information (correction ID) for identifying the correction result, and the correction content.

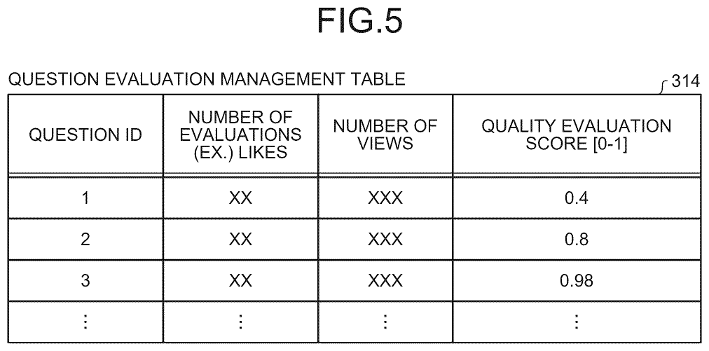

The question evaluation management table 314 is a table for managing information (hereinafter referred to as “question evaluation information”) related to evaluations of the quality of questions, received from users (evaluators). FIG. 5 is a diagram illustrating an example of the question evaluation management table 314. Question evaluation records (question evaluation information) managed in the question evaluation management table 314 include: a question ID for identifying a question; an evaluation (the evaluation count, which is the number of evaluations represented by the number of users who pressed a “like” button for the question content) received from at least one user different from the questioner (although including the questioner is permissible); the number of views of the question; and a score (quality evaluation score) determined based on the number of evaluation and the number of views. That is, both the evaluation received from users and the score (final evaluation) determined based on that evaluation are managed as question evaluation information.

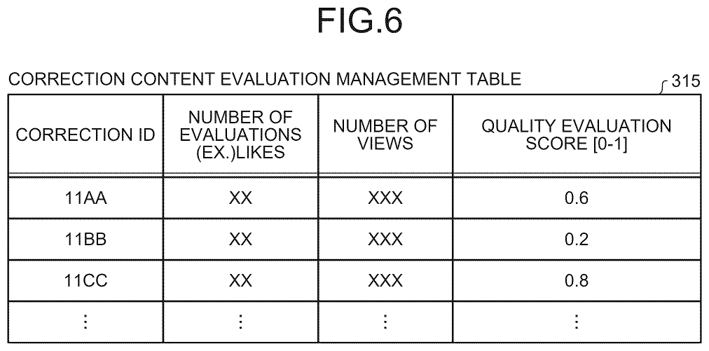

The correction content evaluation management table 315 is a table for managing information (hereinafter referred to as “correction content evaluation information”) related to evaluations of the quality of correction content. FIG. 6 is a diagram illustrating an example of the correction content evaluation management table 315. Correction content evaluation records (correction content evaluation information) managed in the correction content evaluation management table 315 include: information (correction ID) for identifying correction content; an evaluation (the evaluation count, which is the number of evaluations represented by the number of users who pressed a “like” button for the correction content) received from at least one user other than the user who made the correction; the number of views of the correction content; and a score (quality evaluation score) determined based on the number of evaluation and the number of views. That is, both the evaluation received from users and the score (final evaluation) determined based on that evaluation are managed as correction content evaluation information. A method for the evaluation is not limited to the counting of the number of “likes”. The evaluation may instead be performed based on the number of times a different button such as a “useful” button was pressed. Alternatively, the evaluations may be performed by using a score value such as a rating from one to five stars. The evaluation may be a value automatically calculated based on predetermined rules or functions rather than evaluation values directly input by users (evaluators). For example, the evaluation value may be represented by the number of times the machine learning model cited the corresponding question or correction result.

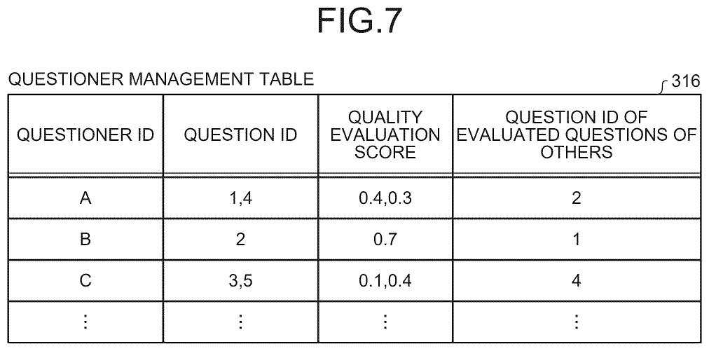

The questioner management table 316 is a table for managing information (hereinafter referred to as “questioner information”) related to users who asked questions. FIG. 7 is a diagram illustrating an example of the questioner management table 316. Questioner records (questioner information) managed in the questioner management table 316 include: information (questioner ID) for identifying the user who asked a question; a question ID for identifying a question from the user; a quality evaluation score obtained for questions by the user; and a question ID identifying questions of others evaluated by the user.

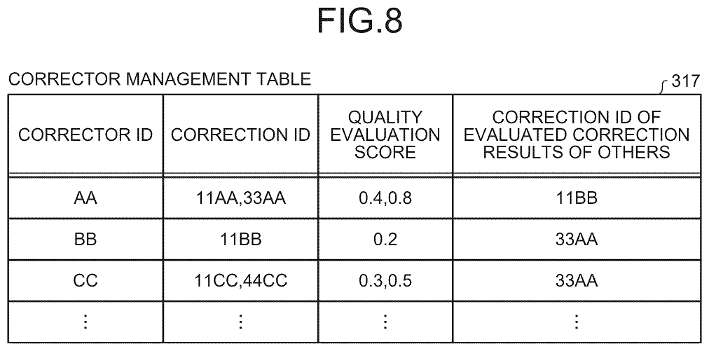

The corrector management table 317 is a table for managing information (hereinafter referred to as “corrector information”) related to users who made corrections. FIG. 8 is a diagram illustrating an example of the corrector management table 317. Corrector records (corrector information) managed in the corrector management table 317 include: information (corrector ID) for identifying the user who made a correction; a correction ID for identifying a correction result by the user; a quality evaluation score obtained for corrections made by the user; and a correction ID identifying correction results of others evaluated by the user.

The trained model storage 232 of the DB server 23 stores a trained machine learning model (parameters constituting the model). The machine learning model may be, for example, a pre-trained model obtained in an external apparatus. The DB server 23 may not store a trained machine learning model, and the response apparatus 2 may utilize an API or the like provided by another server to use the machine learning model.

The viewing log storage 233 of the DB server 23 stores logs of questions and corrections viewed by users via the user terminal 1. The viewing log may be a general access log. The viewing log contains information sufficient to aggregate the number of views for a question ID and a correction ID.

### (Response to Questions)

The question input unit 111 of the user terminal 1 receives input of a question from a user. A question is assumed to be text data, but may alternatively be image data, audio data, or the like. The question input unit 111 transmits a question received from a user to the response apparatus 2. For example, the question input unit 111 may transmit the question by including it in an HTTP request.

The question receiving unit 211 of the web server 21 can receive a question transmitted from the user terminal 1. For example, the question receiving unit 211 may decode a question encoded in an HTTP request, and transmit the decoded question to the application server 22.

The response unit 221 of the application server 22, upon receiving a question from the web server 21, provides the question to the machine learning model stored in the trained model storage 232 of the database server 23, thereby generating a response to the question. The response unit 221 then transmits the generated response to the response content generation unit 222. The response unit 221 can set the decoded question as the question content, obtain a questioner ID identifying the user of the user terminal 1 that transmitted the question, and generate a new question ID, to create question information. The response unit 221 registers the created question information into the question management table 311 in the data storage 231 of the database server 23.

The response content generation unit 222 of the application server 22 generates display content for the user terminal 1 (hereinafter, “response content” which may be, for example, screen data described in HTML) based on the response received from the response unit 221. The response content generation unit 222 transmits the generated response content to the web server 21. The response content includes the response. The response content may include both the question and the response thereto. The response content may further include the number of evaluations (e.g., the number of “likes”) given for the question.

The response content display unit 212 of the web server 21 receives the response content for displaying the response, from the application server 22 and transmits the received response content to the user terminal 1. In addition to the user terminal 1 from which the question was transmitted, the response content display unit 212 can also transmit the content for displaying the question and response, to other user terminals 1.

The response content display unit 212 of the web server 21 may, in response to a request from a user terminal 1, transmit a message to the response content generation unit 222 of the application server 22. The response content generation unit 222 may read one or more pieces of question information from the question management table 311 of the data storage 231 in the database server 23, obtain corresponding response information from the response management table 312 for each question ID, and generate response content for displaying both the question content and the response content. The response content generation unit 222 transmits the generated response content to the web server 21. The response content display unit 212 may transmit the response content to the user terminal 1 that transmitted the request. The response content generation unit 222 may obtain the number of evaluation corresponding to the question ID, from the question evaluation management table 314 and include it in the response content.

The response content display unit 112 of the user terminal 1 receives the response content transmitted from the web server 21 and displays the response content to the user, based on the received response content.

### <Function for Setting Public/Private Access>

The system may provide functionality to set questions and/or corrections as public or private. In this case, public/private information (publication setting information) may be assigned to the question information stored in the question management table 311 and/or the correction result information stored in the correction result management table 313. Only the question information and correction result information indicating “public” in the publication setting information may be disclosed to general users.

Even when correction content is set to private, a dedicated learning model for the users who are the correctors of the private correction content may be prepared, and the private correction content may be used for training the dedicated learning model. In such a case, for example, proprietary know-how may be protected while simultaneously cultivating a company-specific dedicated learning model.

### (Mask Setting Function)

A portion of the question and/or correction content may be masked. In this case, for example, characters or conditions to be masked may be set for each question in the question information and/or each correction content in the correction result information. The characters set to be masked are replaced with substitute characters. Portions of the question and/or correction content, which meet the set conditions, are replaced with substitute characters. These masked data may be disclosed and used for retraining of the machine learning model.

### (Evaluation of Questions)

The question evaluation input unit 113 of the user terminal 1 receives an evaluation input regarding a question, from a user. The question evaluation input unit 113 may, for example, accept a “like” input for a question submitted by a user different from the user operating the user terminal 1 to input the evaluation, when the operating user thinks that the question of another user is a good question. The question evaluation input unit 113 transmits the evaluation for the accepted question (e.g., “like”) together with the question ID identifying the question, to the response apparatus 2.

The question evaluation receiving unit 213 of the web server 21 receives an evaluation (e.g., “like”) for a question, from the user terminal 1. The question evaluation receiving unit 213 may increment the evaluation count in the question evaluation management table 314 corresponding to the question ID identifying the question.

### (Correction of Responses)

The response correction input unit 114 of the user terminal 1 may receive correction content from a user regarding a response viewed by the user. The response correction input unit 114 transmits the received correction content to the web server 21, together with the response ID identifying the response and the corrector ID identifying the user.

The correction result receiving unit 214 of the web server 21 receives correction content for a response, from a user. The correction result receiving unit 214 transmits the received correction content to the application server 22 together with the response ID and the corrector ID.

The correction result content generation unit 223 of the application server 22, upon receiving correction content transmitted from the web server 21, may register correction result information: including the response ID; the corrector ID; a newly assigned correction ID (which may alternatively be assigned by the database server 23); and the correction content, into the correction result management table 313 in the data storage 231. The correction result content generation unit 223 may generate content indicating acceptance of the correction result (hereinafter, “correction result content”). The correction result content may include the correction result received from the web server 21. The correction result content may further include, for example, a list of past correction results registered in the correction result management table 313. The correction result content generation unit 223 transmits the correction result content to the web server 21.

The correction result display unit 215 of the web server 21 transmits to the user terminal 1 the correction result content received from the application server 22.

The correction result display unit 115 of the user terminal 1 displays the correction content to the user based on the correction result content received from the web server 21.

The correction result display unit 215 of the web server 21 may, in response to a request from the user terminal 1, transmit a message to the correction result content generation unit 223 of the application server 22. The correction result content generation unit 223 may read one or more response records from the response management table 312 in the data storage 231 of the database server 23, obtain corresponding question content from the question management table 311 for each question ID, obtain correction result information corresponding to the response ID from the correction result management table 313, and generate correction result content for displaying the question content, the response content, and one or more correction contents. The correction result content generation unit 223 transmits the generated correction result content to the web server 21. The correction result display unit 215 may transmit the correction result content to the user terminal that transmitted the request. The correction result content generation unit 223 may further obtain the number of evaluation corresponding to the correction ID from the correction content evaluation management table 315 and include it in the correction result content.

### (Evaluation of Corrections)

The correction evaluation input unit 116 of the user terminal 1 receives an evaluation input from a user regarding a correction result. The correction evaluation input unit 116 may, for example, accept a “like” input for a correction result submitted by a user different from the user operating the user terminal 1 to input the evaluation, when the operating user thinks that the correction result of another user is a good correction. The correction evaluation input unit 116 transmits the evaluation for the accepted correction result (e.g., “like”) together with the correction ID identifying the correction result, to the response apparatus 2.

The correction evaluation receiving unit 216 of the web server 21 receives an evaluation (e.g., “like”) for a correction result from the user terminal 1. The correction evaluation receiving unit 216 may increment the evaluation count in the correction content evaluation management table 315 corresponding to the correction ID identifying the correction result.

### (Machine Learning)

The learning unit 224 (update unit) of the application server 22 updates (re-trains) the machine learning model using correction results in which a user has corrected the response generated by the machine learning model for a given question.

For example, the learning unit 224 may read, for each question record registered in the question management table 311, the correction result information corresponding to the question ID, from the correction result management table 313, and update the machine learning model by training it on the correction content included in the correction result information. The learning unit 224 may, for example, perform the training on the combination of the question and the corresponding correction content.

The learning unit 224 may perform re-training only when the correction result is closed information (i.e., non-public information). The learning unit 224 may refrain from performing re-training on public information.

As to whether the information is public, for example, the learning unit 224 may input the question, or a keyword or phrase included in the question, into a publicly available search engine and determine whether the search results include content similar to the correction result. If such similar content is found, the learning unit 224 may determine that the correction result constitutes public information. Similarly, the learning unit 224 may input the correction result itself, or a keyword or phrase included therein, into a publicly available search engine and determine whether the search results include content similar to the correction result. If such similar content is found, the learning unit 224 may determine that the correction result constitutes public information.

With respect to whether information is public, the response apparatus 2 may be provided with an external public information storage that stores external public information such as information disclosed on websites (e.g., academic papers, Q&A sites) or past correction results. The learning unit 224 may determine the degree of similarity between the correction result and the information stored in the external public information storage, and if the similarity is equal to or greater than a predetermined threshold, the learning unit 224 may determine that the correction result constitutes public information. The learning unit 224 may compare the output obtained from the trained model stored in the trained model storage 232 by inputting the question, with the correction result, and if the similarity is equal to or greater than a predetermined threshold, determine that the correction result constitutes public information.

The learning unit 224 may perform machine learning using only correction results whose evaluation count and/or quality evaluation score are each equal to or greater than a predetermined threshold. For example, for each question record registered in the question management table 311, the learning unit 224 may perform machine learning using only those correction result records corresponding to the question ID that have an evaluation count equal to or greater than the threshold and/or a quality evaluation score equal to or greater than the threshold (which may or may not be the same as the threshold for the evaluation count).

The learning unit 224 may perform machine learning using only questions whose evaluation count and/or quality evaluation score are each equal to or greater than a predetermined threshold. For example, among the question records registered in the question management table 311, the learning unit 224 may select only those records each having an evaluation count equal to or greater than the threshold and/or a quality evaluation score equal to or greater than the threshold (which may or may not be the same as the threshold for the evaluation count), and perform machine learning using the question content of the selected question records together with the correction content of the correction result records corresponding to the question IDs of the selected question records. In addition, among the correction result records corresponding to the question record, the learning unit 224 may further select only those records each having an evaluation count equal to or greater than a predetermined threshold and/or a quality evaluation score equal to or greater than a predetermined threshold.

### (Learning Data Sources)

The learning unit 224 may use, as data for re-training, not only correction results but also academic papers, explanatory articles from web pages, and the like. In such cases, the incentive number calculation unit 227 described later may provide incentives to the authors of the papers and the creators of the web pages.

### (Determination of Question Quality)

The question quality determination unit 225 of the application server 22 determines the quality of questions. For each question evaluation record registered in the question evaluation management table 314, the question quality determination unit 225 can determine a quality evaluation score based on, for example, the evaluation count. For example, the question quality determination unit 225 may use the question evaluation records to calculate the quality evaluation score as the value obtained by dividing the evaluation count, which is the number of evaluations, by the number of views. Instead of the number of views, the number of unique users who viewed the question may be used for the calculation. The question quality determination unit 225 generates content for displaying the quality evaluation score of the questions (hereinafter referred to as “question quality evaluation content”). The question quality evaluation content may be used, for example, to present high-quality questions to users. The question quality determination unit 225 may generate, for one or more question evaluation records, screen data written in HTML for displaying the quality evaluation scores. The question quality determination unit 225 transmits the question quality evaluation content to the web server 21.

The question quality determination result display unit 217 of the web server 21 receives the question quality evaluation content from the application server 22 and provides the received question quality evaluation content to the user terminal 1. The question quality determination result display unit 217 may, in response to a request from the user terminal 1, read question evaluation records from the question evaluation management table 314, generate the question quality evaluation content, and transmit the response to the user terminal 1.

The question quality determination result display unit 117 of the user terminal 1 receives the question quality evaluation content transmitted from the web server 21, and displays to the user a screen showing the quality evaluation score of the question, based on the question quality evaluation content.

### (Determination of Correction Quality)

The correction quality determination unit 226 of the application server 22 determines the quality of correction content. For each correction content evaluation record registered in the correction content evaluation management table 315, the correction quality determination unit 226 may determine a quality evaluation score based on, for example, the evaluation count. For example, the correction quality determination unit 226 may use the correction evaluation records to calculate the quality evaluation score as the value obtained by dividing the evaluation count, which is the number of evaluation, by the number of views. Instead of the number of views, the number of unique users who viewed the correction content may be used for the calculation. The correction quality determination unit 226 generates content for displaying the quality evaluation score of the correction content (hereinafter referred to as “correction quality evaluation content”). The correction quality evaluation content may, for example, serve as content for providing a best answer to users. The correction quality determination unit 226 may generate, for one or more correction evaluation records, screen data written in HTML for displaying the quality evaluation scores. The correction quality determination unit 226 transmits the correction quality evaluation content to the web server 21.

The correction quality determination result display unit 218 of the web server 21 receives the correction quality evaluation content from the application server 22 and provides the received correction quality evaluation content to the user terminal 1. The correction quality determination result display unit 218 may, in response to a request from the user terminal 1, read correction evaluation records from the correction content evaluation management table 315, generate the correction quality evaluation content, and transmit the response to the user terminal 1.

The correction quality determination result display unit 118 of the user terminal 1 receives the correction quality evaluation content transmitted from the web server 21, and displays to the user a screen showing the quality evaluation score of the correction content based on the correction quality evaluation content.

### (Granting Incentives for Corrections)

The incentive number calculation unit 227 of the application server 22 determines the amount of incentive to be granted to at least one of the following: a user who asked a question; a user who evaluated the question; a user who corrected the response; and a user who evaluated the correction content.

The incentive may be, for example, points tradable in the market, virtual currency, or tokens based on blockchain technology. The incentive may also be coupons or the like. Digital content may be granted as the incentive. For example, the incentive may be a lottery right for digital content or a physical prize, in which the number of lottery attempts corresponds to the amount of incentive, or the winning probability corresponds to the amount of incentive.

For example, incentives may be granted to both the user who asked a question and the user who corrected the response. The amounts of incentives granted to the user who asked the question may be different from the amounts of incentives granted to the user who corrected the response. For example, a larger amount of incentive may be granted to the user who performed the correction than to the user who asked the question.

The incentive number calculation unit 227 may determine the amount of incentive granted on a per-user basis. For example, the incentive number calculation unit 227 may calculate an incentive for the user who asked a question (questioner) and an incentive for the user who corrected a response (corrector). The incentive number calculation unit 227 may determine the amount of incentive such that a user who provided a question and/or correction content that received a larger number of evaluations and/or a higher quality evaluation score is granted a larger amount of incentive.

### (Incentives for Questioners)

The incentive number calculation unit 227 may determine the amount of incentive to be granted to the user who asked a question based on at least one of: the activeness of the question; the quality of the question; and the quality of the questioner. The activeness of the question refers to the degree to which a user actively asks questions. The activeness of the question may be evaluated, for example, by the number of questions asked by the user or by a basic statistical measure thereof. The quality of the question refers to the degree to which many users consider the question to be good. The quality of the question may be evaluated, for example, by the number of “likes” received from other users for the question asked by the user or by a basic statistical measure thereof. The quality of the questioner refers to whether the user who asked the question has discernment, that is, the degree to which other users also consider good the questions that the user considers good. The quality of the questioner may be evaluated, for example, by the number of “likes” given by other users to questions that the user has liked, or by a basic statistical measure thereof.

The incentive number calculation unit 227 may calculate the amount of incentive according to the following equation, based on the evaluation value of the activeness of the question (question activeness), the evaluation value of the quality of the question (question quality), and the evaluation value of the quality of the questioner (questioner quality), which are described above:

I=a×Qa+b×Qb+c×Qc

where I is the incentive amount, Qa is the question activeness, Qb is the question quality, Qc is the questioner Quality, and a, b and c are coefficients.

The degree of emphasis placed on the question activeness, the question quality, and the questioner quality may be adjusted by the coefficients. The coefficients may be arbitrarily set. The above equation is not limited to a linear summation. For example, an equation may be employed in which at least one of the question activeness, the question quality, and the questioner quality is used as a variable, such that the larger the value of each evaluation metric, the greater the calculated amount of incentive.

### (Incentives for Correctors)

The incentive number calculation unit 227 may determine the amount of incentive to be granted to a user who corrected a response, based on at least one of: activeness of correction; quality of correction; and quality of the corrector. The correction activeness refers to the degree to which a user actively performs corrections. The correction activeness may be evaluated, for example, by the number of corrections made by the user or by a basic statistical measure thereof. The correction quality refers to the degree to which many users consider a correction to be good. The correction quality may be evaluated, for example, by the number of “likes” from other users received for the user's correction, or by a basic statistical measure thereof. The corrector quality refers to whether the user who made the correction has discernment, that is, the degree to which other users also consider good the corrections that the user considers good. The corrector quality may be evaluated, for example, by the number of “likes” given by other users to corrections that the user has “liked”, or by a basic statistical measure thereof.

The incentive number calculation unit 227 may calculate the amount of incentive according to the following equation, based on the evaluation values of correction activeness, correction quality, and corrector quality, which are described above:

I=d×Qd+e×Qe+f×Qf

where I is the incentive amount, Qd is the correction activeness, Qe is the correction quality, Of is the corrector quality, and d, e and f are coefficients.

The degree of emphasis placed on the correction activeness, the correction quality, and the corrector quality may be adjusted by the coefficients. The coefficients may be arbitrarily set. The above equation is not limited to a linear summation. For example, an equation may be employed in which at least one of the correction activeness, the correction quality, and the corrector quality is used as a variable, such that the larger the value of each evaluation metric, the greater the calculated amount of incentive.

### (Incentives for Evaluators)

Incentives may also be granted to users who evaluated a question and/or a correction result. In this case, the incentive number calculation unit 227 may determine the amount of incentive to be granted to the user who evaluated a question or correction result, based on at least one of: evaluation activeness; evaluation quality; and evaluator quality. The evaluation activeness refers to the degree to which a user actively performs evaluations. The evaluation activeness may be evaluated, for example, by the number of evaluations such as “likes” performed by the user, or by a basic statistical measure thereof. The evaluation quality refers to the degree to which the user gives favorable evaluations to questions or correction results that many other users also consider favorable. The evaluation quality may be evaluated, for example, by the number of “likes” from other users attached to questions or correction results that the user has “liked,” or by a basic statistical measure thereof.

### (Incentive Calculation Per Question/Correction)

The incentive number calculation unit 227 may also grant incentives on a per-question and/or per-correction basis. For example, the incentive number calculation unit 227 may grant an amount of incentive corresponding to the number of views of a question to the questioner, and an amount of incentive corresponding to the number of views of correction to the corrector. The incentive number calculation unit 227 may be configured such that each time a question or correction is viewed, the questioner or corrector continues to receive incentives.

The incentive number calculation unit 227 may issue a non-fungible token (NFT) representing the right to receive incentives. For example, the incentive number calculation unit 227 may issue NFTs associated with a question and/or correction. The issuance of NFTs may be performed using general blockchain technology, and thus will not be described in detail herein. The incentive number calculation unit 227 may grant incentives for a question and/or correction to the owner of the corresponding NFT. The NFTs may be tradable.

The incentive number calculation unit 227 may grant incentives when the correction result is used by the learning unit 224 for retraining.

The incentive number calculation unit 227 may grant a larger amount of incentive for correction results that are non-public information (closed data) than for correction results that are public information. Alternatively, the incentive number calculation unit 227 may be configured not to grant incentives for public information.

The incentive number calculation unit 227 transmits to the web server 21 content (hereinafter referred to as “incentive content”) for displaying the determined incentive type and amount (grant amount).

The incentive display unit 219 of the web server 21 transmits to the user terminal 1 the incentive content received from the application server 22. An incentive management table may be provided in the data storage 231, in which the contents and amounts of incentives calculated by the incentive number calculation unit 227 are stored in association with the user ID of the user to whom the incentives are granted. The incentive display unit 219 may, in response to a request from a user terminal 1, read, from the incentive management table, the contents and amounts of incentives corresponding to the requesting user, generate incentive content, and transmit the generated incentive content to the user terminal 1.

The incentive number display unit 119 of the user terminal 1 can display, on a screen, the contents and amounts of incentives granted to the user, based on the incentive content transmitted from the web server 21.

### (Viewing Log)

The viewing log acquisition unit 220 of the web server 21 can acquire access logs of accesses made from user terminals 1 to the web server 21, for example. The viewing log acquisition unit 220 can acquire general access logs of the web server. The viewing log acquisition unit 220 can register the acquired viewing logs in a viewing log storage 233 managed by the database server 23.

### <Operation>

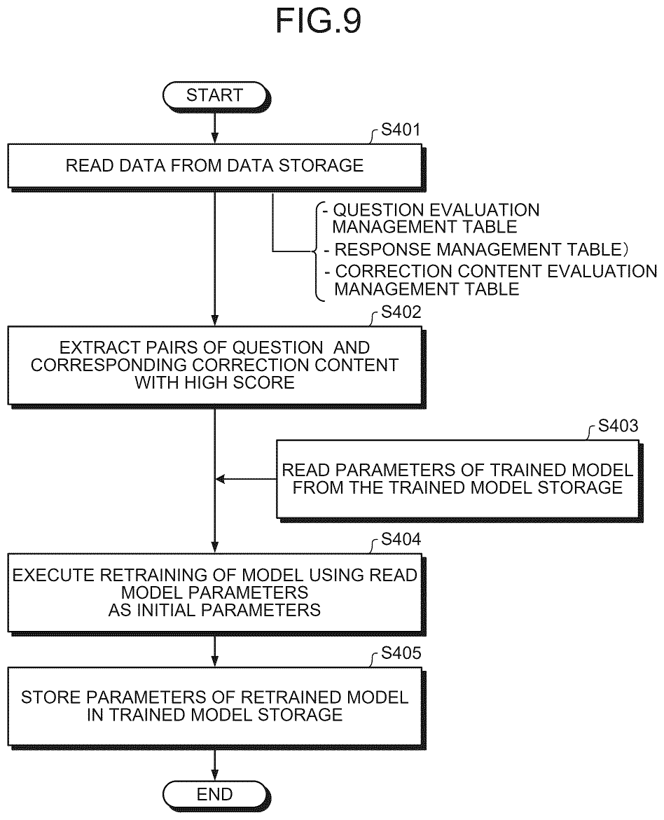

FIG. 9 is a diagram showing an example of the processing flow of the learning unit 224. The learning unit 224 reads data from the response management table 312, the question evaluation management table 314, and the correction content evaluation management table 315 in the data storage 231 (S401). The learning unit 224 refers to the quality evaluation scores of the question evaluation management table 314 and selects questions having a score equal to or greater than a predetermined threshold. The learning unit 224 refers to the response management table 312 for the correction ID corresponding to the selected question, and refers to the quality evaluation score in the correction content evaluation management table 315 corresponding to the correction ID, and selects correction results with scores equal to or greater than a predetermined threshold (S402). The learning unit 224 reads parameters of a trained model from the trained model storage 232 (S403). The learning unit 224 uses the model parameters read in step S403 as initial parameters, uses the selected pairs of high-quality questions and correction results extracted in step S402 as training data, and executes retraining of the model (S404). When training is completed, the learning unit 224 stores the trained model parameters in the trained model storage 232 (S405). The retraining (fine-tuning) by machine learning may employ general techniques.

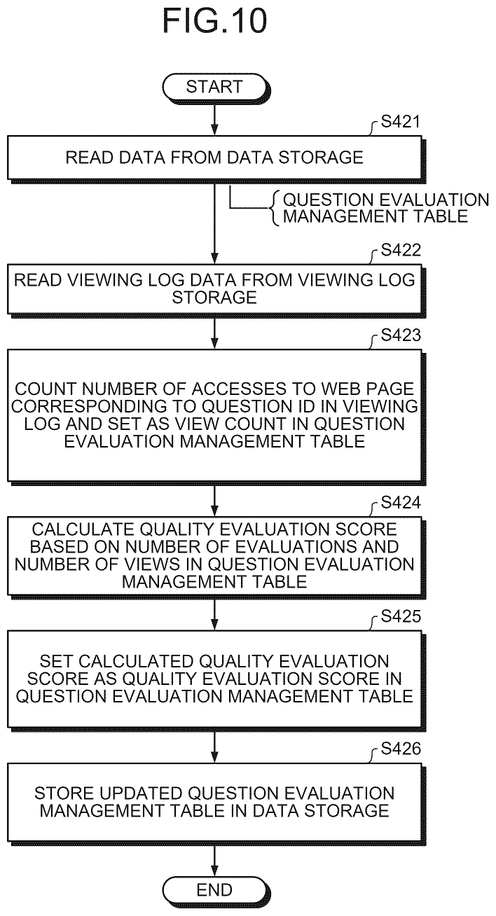

FIG. 10 is a diagram showing an example of the processing flow of the question quality determination unit 225. The question quality determination unit 225 reads data from the question evaluation management table 314 in the data storage 231 (S421). The question quality determination unit 225 reads viewing log data from the viewing log storage 233 (S422). The question quality determination unit 225 counts the number of accesses (views) to the web page corresponding to the question ID from the viewing log, and sets this count as the view count of the question evaluation information managed in the question evaluation management table 314 (S423). The question quality determination unit 225 calculates a quality evaluation score based on the number of evaluations (likes) and the number of views from the question evaluation management table 314 (S424). The question quality determination unit 225 sets the calculated quality evaluation score as the quality evaluation score of the question evaluation information managed in the question evaluation management table 314 (S425). The question quality determination unit 225 stores the updated question evaluation management table 314 in the data storage 231 (S426).

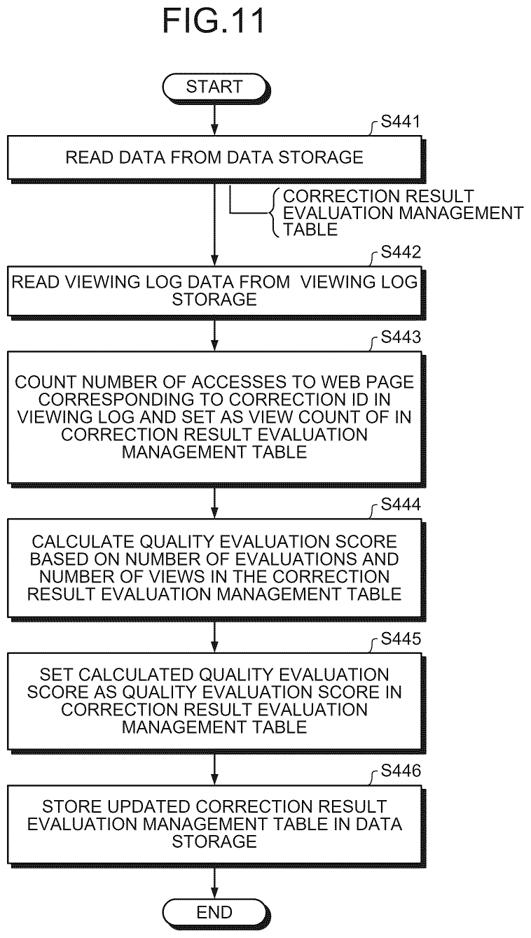

FIG. 11 is a diagram showing an example of the processing flow of the correction quality determination unit 226. The correction quality determination unit 226 reads data from the correction content evaluation management table 315 in the data storage 231 (S441). The correction quality determination unit 226 reads viewing log data from the viewing log storage 233 (S442). The correction quality determination unit 226 counts the number of accesses (views) to the web page corresponding to the correction ID from the viewing log, and sets this count as the view count of the correction evaluation information managed in the correction content evaluation management table 315 (S443). The correction quality determination unit 226 calculates a quality evaluation score based on the number of evaluations (likes) and the number of views from the correction content evaluation management table 315 (S444). The correction quality determination unit 226 sets the calculated quality evaluation score as the quality evaluation score of the correction evaluation information managed in the correction content evaluation management table 315 (S445). The correction quality determination unit 226 stores the updated correction content evaluation management table 315 in the data storage 231 (S446).

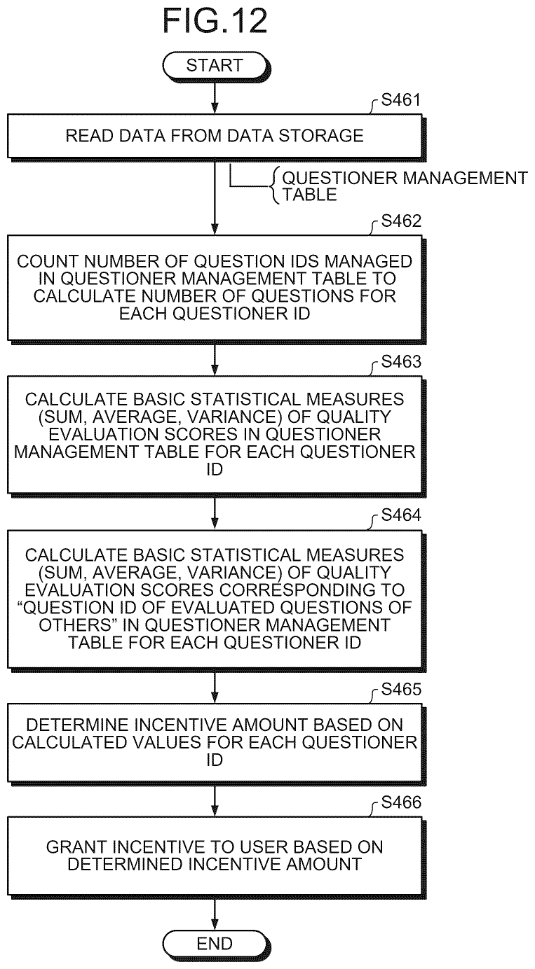

FIG. 12 is a diagram showing the processing flow of incentive calculation for users who submitted questions. The incentive number calculation unit 227 reads data from the questioner management table 316 in the data storage 231 (S461). The incentive number calculation unit 227 counts, for each questioner ID, the number of question IDs managed in the questioner information of the questioner management table 316 to calculate the number of questions (S462). The incentive number calculation unit 227 calculates, for each questioner ID, basic statistical measures (such as sum, average, variance) of the quality scores obtained in the questioner information managed in the questioner management table 316 (S463). The incentive number calculation unit 227 calculates, for each questioner ID, basic statistical measures (such as sum, average, variance) of the quality evaluation scores corresponding to each question ID of “question ID of evaluated questions of others” in the questioner management table 316 (S464). The incentive number calculation unit 227 determines the incentive amount for each questioner ID based on the values calculated above (S465). Based on the determined incentive amount, the incentive number calculation unit 227 may grant incentives to the users who posed questions (S466).

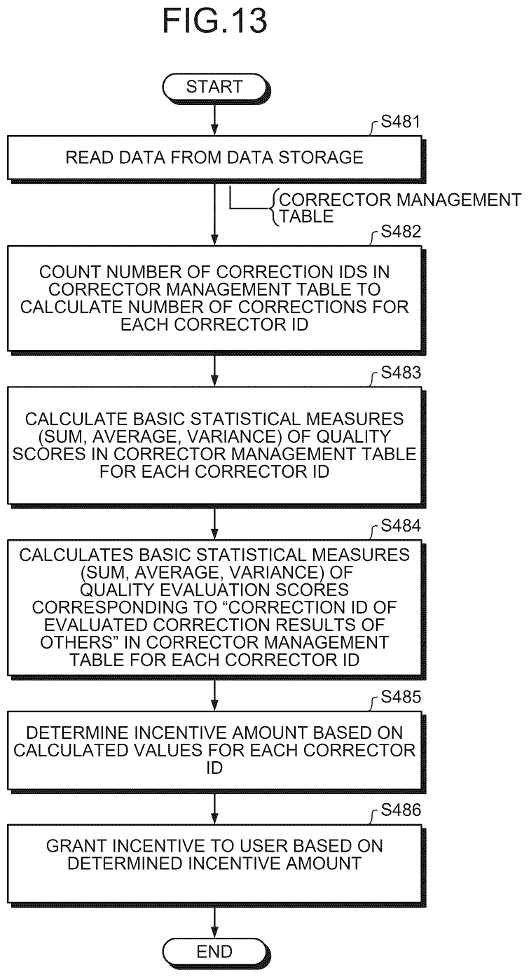

FIG. 13 is a diagram showing the processing flow of incentive calculation for users who corrected responses. The incentive number calculation unit 227 reads data from the corrector management table 317 in the data storage 231 (S481). The incentive number calculation unit 227 counts, for each corrector ID, the number of correction IDs managed in the corrector information of the corrector management table 317 to calculate the number of corrections (S482). The incentive number calculation unit 227 calculates, for each corrector ID, basic statistical measures (such as sum, average, variance) of the quality scores obtained in the corrector information managed in the corrector management table 317 (S483). The incentive number calculation unit 227 calculates, for each corrector ID, basic statistical measures (such as sum, average, variance) of the quality evaluation scores corresponding to each correction ID of “correction ID of evaluated correction results of others” in the corrector management table 317 (S484). The incentive number calculation unit 227 determines the incentive amount for each corrector ID based on the values calculated above (S485). Based on the determined incentive amount, the incentive number calculation unit 227 may grant incentives to the users who performed corrections (S486).

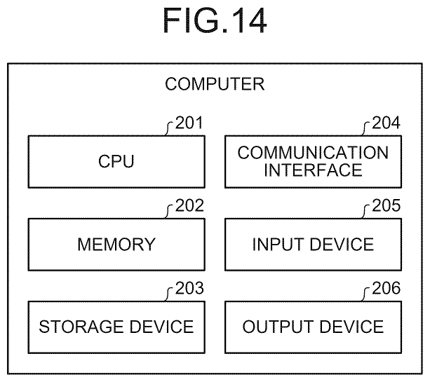

FIG. 14 is a diagram showing an example hardware configuration of a computer. The computer or a part of the computer may correspond to the processing circuitry, which may include hardware and/or software components such as a processor, memory, and programs executed thereon. The illustrated configuration is merely an example, and other configurations may also be employed for the computer. The user terminal 1 and the response apparatus 2 (web server 21, application server 22, database server 23) may be implemented by the computer shown in FIG. 14.

The computer comprises a CPU 201, a memory 202, a storage device 203, a communication interface 204, an input device 205, and an output device 206. The storage device 203 is, for example, a hard disk drive, a solid-state drive, or a flash memory, and stores various data and programs. The communication interface 204 is an interface for connecting to a communication network. The communication interface 204 may include, for example, an Ethernet adapter, a modem for connecting to the public switched telephone network, a wireless communication device for wireless communication, or connectors such as a USB (Universal Serial Bus) connector or an RS-232C connector for serial communication. The input device 205 which may correspond to the input unit is a device for inputting data, such as a keyboard, mouse, touch panel, button, or microphone. The output device 206 which may correspond to the output unit is a device for outputting data, such as a display, printer, or speaker. Each functional unit provided in the user terminal 1 and the response apparatus 2 (web server 21, application server 22, database server 23) is realized by the CPU 201 executing a program stored in the storage device 203 after loading it into the memory 202. Each functional unit described in this embodiment may also be realized as part of the memory area provided by the memory 202 and/or the storage device 203, which function as a non-transitory computer-readable medium storing instructions executable by a processor.

Although the embodiment has been described above, the embodiment is provided to facilitate understanding of the present invention and is not intended to limit the present invention. The present invention may be modified or improved without departing from the spirit thereof, and equivalents thereof are also encompassed within the scope of the present invention.

<Selection from Multiple Candidates>

For example, in the present embodiment, it is assumed that the output (response) from the trained model is one response to one question. However, a plurality of outputs may be generated by using the trained model. For example, the response unit 221 may repeatedly input the question to the trained model to attempt generating multiple responses. When the trained model is a generative model, different responses may be generated by increasing a randomness parameter (e.g., the temperature parameter of GPT).

Multiple outputs (results from the trained model) may be generated, and a corrector may select the output considered to be of the highest quality, and then correct the selected output. In this case, the learning unit 224 may also receive information specifying which output was selected by the corrector. By retraining the trained model using the selected output together with the question and the correction result, the quality of the outputs of the trained model can be improved.

Multiple outputs may be generated, and viewers, without performing corrections, may select which of the multiple outputs is considered to be of the highest quality. In this case, the learning unit 224 may also retrain the trained model using information indicating which output was selected by the viewers (e.g., the selected output and the number of viewers who selected it), thereby improving the quality of the outputs of the trained model.

The response unit 221 may cause the trained model to generate multiple outputs for a question and automatically select, as the final response, the output determined to be of the highest quality. The quality may be determined based on user receptivity or the appropriateness of the response, according to rule-based criteria or predetermined conditions.

### <Provision of References>

The response unit 221 may provide, together with the response from the trained model, information that may serve as reference material for correction. Reference information may be, for example, collected from information sources such as websites, blogs, or academic papers. The similarity between the collected data and the response from the trained model may be determined, and those with similarity equal to or greater than a predetermined threshold may be selected as reference information. The response unit 221 may display, in a list, both the response from the trained model and the selected reference information.

When a corrector relies on certain information as a reference or basis in performing a correction, such information may also be provided together at the time of correction, and may be utilized as retraining data.

What is claimed is:

1. An information processing system comprising:
an input data receiving unit configured to receive input data from a first user;
a processing circuitry configured to provide the input data to a machine learning model that has been trained through machine learning, and to cause the machine learning model to generate output data;
an output unit configured to output the output data in a manner viewable by a second user different from the first user;
a correction result receiving unit configured to receive a correction result in which the output data is corrected by the second user;
an incentive granting unit configured to grant an incentive to the second user who has provided the correction result; and
a correction evaluation receiving unit configured to receive an evaluation value for the correction result from a third user,
wherein the incentive granting unit determines an amount of the incentive based on
a correction activeness value based on a number of correction results provided by the second user, and
a correction quality value based on an aggregate of the evaluation values from the third user for the correction results provided by the second user.

2. An information processing system comprising:
an input data receiving unit configured to receive input data from a first user;
a processing circuitry configured to provide the input data to a machine learning model that has been trained through machine learning, and to cause the machine learning model to generate output data;
an output unit configured to output the output data in a manner viewable by a second user different from the first user;
a correction result receiving unit configured to receive a correction result in which the output data is corrected by the second user;
an incentive granting unit configured to grant an incentive to the first user who has provided the input data; and
an input evaluation receiving unit configured to receive an evaluation value for the input data from a third user,
wherein the incentive granting unit determines an amount of the incentive based on
a question activeness value based on a number of input data provided by the first user, and
a question quality value based on an aggregate of the evaluation values from the third user for the input data provided by the first user.

3. An information processing system comprising:
an input data receiving unit configured to receive input data from a first user;
a processing circuitry configured to provide the input data to a machine learning model that has been trained through machine learning, and to cause the machine learning model to generate output data;
an output unit configured to output the output data in a manner viewable by a second user different from the first user;
a correction result receiving unit configured to receive a correction result in which the output data is corrected by the second user;
a correction evaluation receiving unit configured to receive an evaluation value for the correction result from a third user; and
an incentive granting unit configured to grant an incentive to the third user,
wherein the incentive granting unit determines an amount of the incentive based on
an evaluation activeness value based on a number of evaluation values provided by the third user, and
an evaluator quality value based on a number of other users who have provided evaluation values identical to the evaluation value provided by the third user for the same correction result.

4. The information processing system according to claim 1, further comprising an update unit configured to update the learning model using the correction result.

5. The information processing system according to claim 4, further comprising
a correction evaluation receiving unit configured to receive an evaluation value from a third user for the correction result,
wherein the output unit outputs the input data and the correction result in a manner viewable by the third user,
the correction result receiving unit receives correction results from a plurality of the second users, and
the update unit selects the correction result based on the evaluation value and updates the learning model using the selected correction result.

6. The information processing system according to claim 5, further comprising
a correction quality determination unit configured to determine a quality of the correction result by aggregating at least the evaluation values,
wherein the update unit selects at least a portion of the correction results based on the quality.

7. The information processing system according to claim 6, wherein the correction quality determination unit determines the quality based on at least an aggregate value of the evaluation values and a number of the third users who have viewed the correction result.

8. The information processing system according to claim 4, further comprising
an input evaluation receiving unit configured to receive evaluation values from the third user for the input data,
wherein the output unit outputs the input data in a manner viewable by the second user and the third user, and
the update unit updates the trained model using the input data having an evaluation value equal to or greater than a predetermined value and a correction result of the output data corresponding to the input data.

9. The information processing system according to claim 8, further comprising
an input quality determination unit configured to determine a quality of the input data by at least aggregating the evaluation values,
wherein the input evaluation receiving unit receives evaluation values from a plurality of the third users, and
the update unit updates the trained model using the input data having a quality equal to or greater than a predetermined value and the correction result corresponding to the input data.

10. The information processing system according to claim 9, wherein the input quality determination unit determines the quality based at least on an aggregate value of the evaluation values and on a number of the third users who have viewed the input data.

11. The information processing system according to claim 4, further comprising:
a correction evaluation receiving unit configured to receive evaluation values from the third users for the correction results;
a correction quality determination unit configured to determine a correction quality, which is a quality of the correction results, based at least on an aggregate value of the evaluation values and on a number of the third users who have viewed the correction results;
an input evaluation receiving unit configured to receive evaluation values from the third users for the input data; and
an input quality determination unit configured to determine an input quality, which is a quality of the input data, based at least on an aggregate value of the evaluation values and on a number of the third users who have viewed the input data;
wherein the output unit is configured to output the input data and the correction results in a viewable manner to the second users and the third users, and
the update unit is configured to update the learning model using the input data having the input quality equal to or greater than a first predetermined value and the correction results having the correction quality equal to or greater than a second predetermined value.

12. The information processing system according to claim 1, comprising:
an incentive granting unit configured to grant an incentive to the first user who has provided the input data; and
an acquisition unit configured to acquire a number of views of the input data;
wherein the incentive granting unit determines an amount of the incentive based on the number of views of the input data.

13. The information processing system according to claim 1, comprising:
an incentive granting unit configured to grant an incentive to the second user who has provided the correction result; and
an acquisition unit configured to acquire a number of views of the correction result;
wherein the incentive granting unit determines an amount of the incentive based on the number of views of the correction result.

14. The information processing system according to claim 4, wherein the updating unit provides the input data or a keyword included in the input data to a search engine to obtain a search result, determines whether the correction result constitutes publicly available information based on whether the obtained search result includes content similar to the correction result, and updates the learning model using the correction result in a case where the correction result is determined not to be publicly available information.

15. The information processing system according to claim 4, further comprising
a public information storage configured to store public information,
wherein the updating unit determines whether the correction result constitutes publicly available information based on whether content similar to the correction result received from the second user is registered in the public information storage, and updates the learning model using the correction result in a case where the correction result is determined not to be publicly available information.

16. The information processing system according to claim 1, wherein
the system provides the input data or a keyword included in the input data to a search engine to acquire a search result, determines whether the correction result constitutes publicly available information based on whether the acquired search result includes content similar to the correction result, and/or
the system stores public information in a public information storage and determines whether the correction result constitutes publicly available information based on whether content similar to the correction result received from the second user is registered in the public information storage, and
the incentive granting unit determines the amount of incentive such that the incentive amount is greater when the correction result is determined not to be publicly available information than when the correction result is determined to be publicly available information.

17. An information processing program stored on a non-transitory computer-readable medium, the program comprising instructions that, when executed by a computer, cause the computer to perform:
receiving input data from a first user;
providing the input data to a trained machine learning model to generate output data;
outputting the output data in a manner viewable by a second user different from the first user;
receiving, from the second user, a correction result obtained by correcting the output data;
granting an incentive to the second user who provided the correction result; and
receiving, for the correction result, an evaluation value from a third user;
wherein an amount of the incentive is determined based on
a correction activeness value based on a number of correction results provided by the second user, and
a correction quality value based on an aggregate of the evaluation values from the third user for the correction results provided by the second user.

18. An information processing program stored on a non-transitory computer-readable medium, the program comprising instructions that, when executed by a computer, cause the computer to perform:
receiving input data from a first user;
providing the input data to a trained machine learning model to generate output data;
outputting the output data in a manner viewable by a second user different from the first user;
receiving, from the second user, a correction result obtained by correcting the output data;
granting an incentive to the first user who provided the input data; and
receiving, for the input data, an evaluation value from a third user;
wherein an amount of the incentive is determined based on
a question activeness value based on a number of input data provided by the first user, and
a question quality value based on an aggregate of the evaluation values from the third user for the input data provided by the first user.

19. An information processing program stored on a non-transitory computer-readable medium, the program comprising instructions that, when executed by a computer, cause the computer to perform:
receiving input data from a first user;
providing the input data to a trained machine learning model to generate output data;
outputting the output data in a manner viewable by a second user different from the first user;
receiving, from the second user, a correction result obtained by correcting the output data;
receiving, for the correction result, an evaluation value from a third user; and
granting an incentive to the third user;
wherein an amount of the incentive is determined based on
an evaluation activeness value based on a number of evaluation values provided by the third user, and
an evaluator quality value based on a number of other users who have provided evaluation values identical to the evaluation value provided by the third user for the same correction result.

20. An information processing method performed by a computer comprising:
receiving input data from a first user;
providing the input data to a trained machine learning model to generate output data;
outputting the output data in a manner viewable by a second user different from the first user;
receiving, from the second user, a correction result obtained by correcting the output data;
granting an incentive to the second user who provided the correction result; and
receiving an evaluation value from a third user for the correction result;
wherein, an amount of the incentive is determined based on
a correction activeness value based on a number of correction results provided by the second user, and
a correction quality value based on an aggregate of the evaluation values from the third user for the correction results provided by the second.

21. An information processing method performed by a computer comprising:
receiving input data from a first user;
providing the input data to a trained machine learning model to generate output data;
outputting the output data in a manner viewable by a second user different from the first user;
receiving, from the second user, a correction result obtained by correcting the output data;
granting an incentive to the first user who provided the input data; and
receiving an evaluation value from a third user for the input data;
wherein an amount of the incentive is determined based on
a question activeness value based on a number of input data provided by the first user, and
a question quality value based on an aggregate of the evaluation values from the third user for the input data provided by the first user.

22. An information processing method performed by a computer comprising:
receiving input data from a first user;
providing the input data to a trained machine learning model to generate output data;
outputting the output data in a manner viewable by a second user different from the first user;
receiving, from the second user, a correction result obtained by correcting the output data;
receiving an evaluation value from a third user for the correction result; and
granting, by the computer, an incentive to the third user;
wherein an amount of the incentive is determined based on:
an evaluation activeness value based on a number of evaluation values provided by the third user, and
an evaluator quality value based on a number of other users who have provided evaluation values identical to the evaluation value provided by the third user for the same correction result.
